(19) United States
(12) Patent Application Publication
(10) Pub. No.: US 2026/0005917 A1
(43) Pub. Date: Jan. 1, 2026

(54) COMMUNICATION CONTROL DEVICE, COMMUNICATION CONTROL METHOD AND COMPUTER PROGRAM PRODUCT

(71) Applicant: HONDA MOTOR CO.,LTD., Tokyo (JP)

(72) Inventor: Kosei TSUSHIMA, Tokyo (JP)

(21) Appl. No.: 19/246,685

(22) Filed: Jun. 24, 2025

(30) Foreign Application Priority Data
Jun. 28, 2024 (JP) 2024-105168

(51) Int. Cl. H04L 41/0659; H04L 1/1812; H04W 28/06

(52) U.S. Cl. CPC H04L 41/0659; H04L 1/1812; H04W 28/06

(57) ABSTRACT

A communication control device is provided in a mobile object. The communication control device comprises a communication processing unit which performs processing for transmitting, through a wireless communication unit provided in the mobile object, a packet transmitted from a communication device, a detection unit which detects that a communication state in a communication channel through the wireless communication unit has become defective, and a control unit which performs control to transmit an RST packet to the communication device when a defective communication state is detected. The communication control method comprises performing control to transmit, through a wireless communication unit provided in the mobile object, a packet transmitted from a communication device, detecting that a communication state in a communication channel through the wireless communication unit has become defective, and when a defective communication state is detected, performing control to transmit an RST packet to the communication device.

The contents of the following patent applications are incorporated herein by reference: NO. 2024-105168 filed in JP on June 28, 2024.

### BACKGROUND

### 1. TECHNICAL FIELD

The present invention relates to a communication control device, a communication control method, and a computer program product.

### 2. RELATED ART

Patent document 1-3 describes a technique related to an RST packet.

### (Prior Art Documents)

### (Patent Documents)

Patent Document 1: Japanese Patent Application Publication No. 2016-63485

Patent Document 2: Japanese Patent Application Publication No. 2023-33553

Patent Document 3: International Publication No. 2015/52917

### BRIEF DESCRIPTION OF THE DRAWINGS

FIG. 1 schematically illustrates a configuration of a communication system 22 according to one embodiment.

FIG. 2 schematically illustrates an example of a system configuration included in the communication system 22.

FIG. 3 illustrates an example of a sequence according to a communication control method performed at the communication system 22.

FIG. 4 illustrates a transmission history of an RST packet stored in a storage unit 230.

FIG. 5 illustrates an example of a flowchart according to the communication control method performed at a communication control unit 33.

FIG. 6 illustrates an example of a computer 2000.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

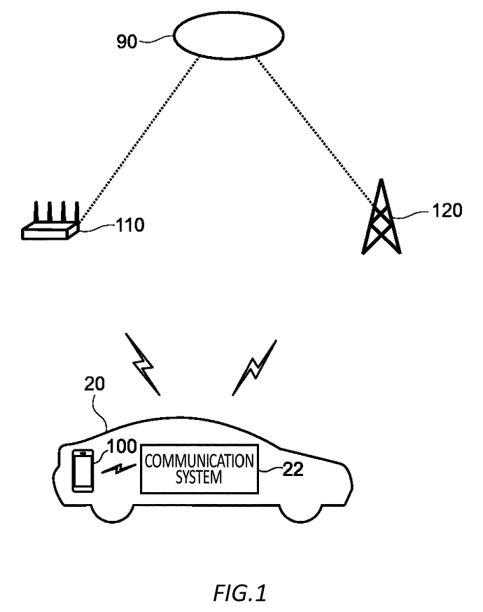

FIG. 1 schematically illustrates a configuration of a communication system 22 according to one embodiment. The communication system 22 is provided in a mobile object 20. The mobile object 20 is movable equipment. The mobile object 20 is an automotive such as a bus, a vehicle such as a train, for example. The vehicle is an example of transportation equipment. The mobile object 20 may be various types of aircraft or the like including an unmanned aircraft.

The communication system 22 has a functionality of performing cellular communication and wireless LAN communication. The communication system 22 can communicate with communication equipment connected to a communication network 90 through a wireless relay device 110 and a wireless base station 120. The communication network 90 includes a computer network such as the Internet, a cellular communication network or the like.

The wireless base station 120 is a cellular communication base station that complies with one or more cellular communication schemes. The cellular communication schemes with which the wireless base station 120 complies may be a communication scheme used for a mobile communication system such as the 4th generation mobile communication system (4G), the 5th generation mobile communication system (5G) , for example. The wireless base station 120 relays communication between a communication device within the communication system 22 and communication equipment connected to the communication network 90.

The wireless relay device 110 has a functionality of relaying wireless LAN communication. The wireless relay device 110 has a functionality of a wireless LAN access point, for example. The wireless relay device 110 relays communication between a communication device within the communication system 22 and communication equipment connected to the communication network 90.

The mobile object 20 in the present embodiment is a vehicle, and the communication system 22 includes a communication network and a plurality of communication devices connected to said communication network. Said plurality of communication devices are ECUs (electronic control units) included in the vehicle, for example.

The communication system 22 has a wireless communication unit that is capable of wirelessly connecting to the wireless relay device 110 and/or the wireless base station 120. The ECU within the communication system 22 can communicate, through said wireless communication unit, with the communication equipment connected to the communication network 90.

In a case where the ECU within the communication system 22 communicates wirelessly with an outside through the wireless communication unit, non-delivery of a packet occurs when a communication state in a communication channel through said wireless communication unit becomes defective. At this time, an RST packet is transmitted to the ECU in the communication system 22. Upon receiving the RST packet, the ECU stops communication through the wireless communication unit. In this manner, the ECU can be prevented from continuing to resend the packet that was non-delivered.

The communication terminal 100 is a terminal possessed by an occupant on the mobile object 20. The communication terminal 100 is, for example, a mobile terminal such as a smartphone. The communication terminal 100 can communicate wirelessly with an outside through the wireless communication unit within the communication system 22.

In a case where the communication terminal 100 is communicating wirelessly with the outside through a wireless communication unit within the communication system 22, when the communication state in the communication channel through said wireless communication unit becomes defective, an RST packet is transmitted to the communication terminal 100 in the communication system 22. Upon receiving the RST packet, the communication terminal 100 stops the communication through the wireless communication unit. In this manner, the communication terminal 100 can be prevented from continuing to resend the packet that was non-delivered.

In this manner, with the communication system 22, the ECU and the communication terminal 100 receives the RST packet from the communication system 22 when the communication state outside becomes defective in a case where it communicates wirelessly with the outside through the wireless communication unit within the communication system 22, so that unnecessary processings such as resending of the packet can be prevented from being continued. Further, upon receiving the RST packet in a case where wireless LAN communication is performed through the wireless relay device 110, for example, the ECU and the communication terminal 100 become capable of performing data communication by switching to cellular communication.

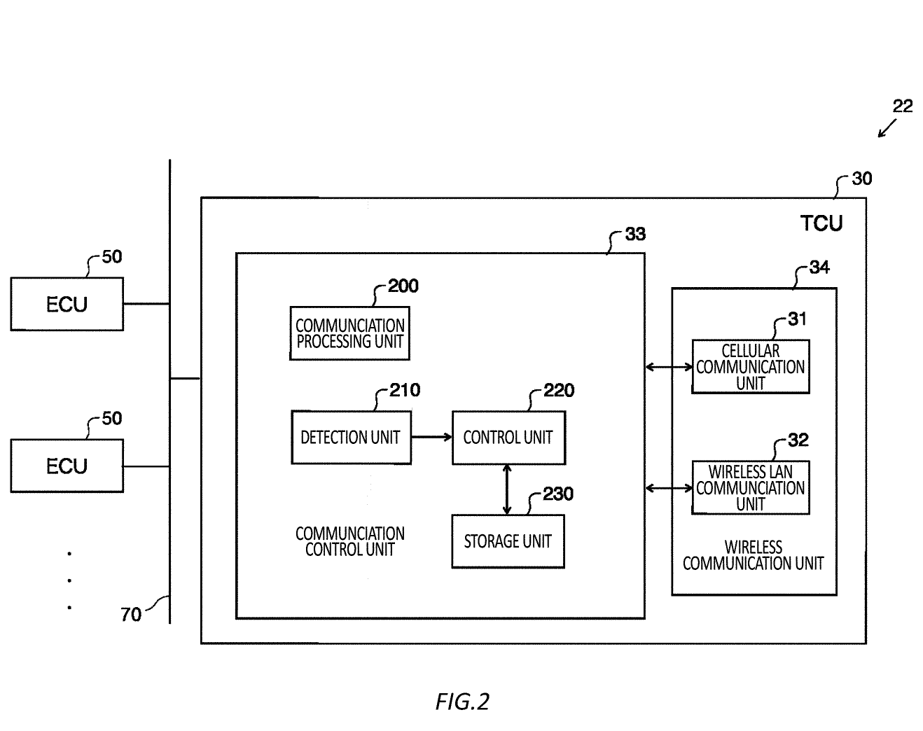

FIG. 2 schematically illustrates an example of a system configuration included in the communication system 22. The communication system 22 includes a TCU 30, an in-vehicle communication network 70, and a plurality of ECUs including one or more ECUs 50. The in-vehicle communication network 70 includes an Ethernet (registered trademark) bus and an Ethernet (registered trademark) hub, for example.

The TCU 30 is a Telematics Control Unit. The TCU 30 includes a communication control unit 33 and a wireless communication unit 34. The wireless communication unit 34 includes a cellular communication unit 31 and a wireless LAN communication unit 32. The cellular communication unit 31 performs cellular communication. The wireless LAN communication unit 32 performs wireless LAN communication.

The communication control unit 33 is responsible for integrated control of the entire TCU 30. The communication control unit 33 is an example of the communication control device. At least a part of the communication control unit 33 is achieved by an operation processing apparatus including a processor. The communication control unit 33 may be achieved by a computer including a CPU, a ROM, a RAM, an I/O, a bus and the like.

The communication control unit 33 includes a communication processing unit 200, a detection unit 210, a control unit 220, and a storage unit 230.

The communication processing unit 200 performs processing to transmit, through the wireless communication unit 34 provided in the mobile object 20, the packet transmitted from the ECU 50. The detection unit 210 detects that a communication state in a communication channel through the wireless communication unit 34 has become defective. For example, the detection unit 210 detects that the communication state has become defective based on a length of a round trip time (RTT), dicontinuation frequency of a PDN session, or the like. In this manner, the detection unit 210 may detect a defective state of IP communication instead of detecting a defective wireless state of RSSI or the like.

The control unit 220 performs control to transmit the RST packet to the ECU 50 when it is detected that the communication state in the communication channel through the wireless communication unit 34 has become defective. The RST packet is transmitted for each communication channel in which a defective communication state has been detected.

In a case where the ECU 50 communicates with the outside of the mobile object 20 through the wireless communication unit 34, when a communication channel ahead of the wireless communication unit 34 has become defective for some reason, the ECU 50 attempts to resend data even though communication is disrupted since it is unable to confirm the situation outside. However, in the present embodiment, since the TCU 30 transmits the RST packet to the ECU 50, the ECU 50 that received the RST packet can recognize the end of the communication. In this manner, the ECU 50 can be suppressed from resending the packet.

When a predetermined condition is met after the RST packet is transmitted to the ECU 50, the control unit 220 starts a processing (also called a DROP processing) of discarding a packet from the ECU 50 that should be transmitted through the wireless communication unit 34. Depending on the setting or implementation of the ECU 50, even when the ECU 50 transmits the RST packet, the ECU 50 may not stop the resending of the packet. Therefore, the control unit 220 starts the DROP processing when the predetermined condition is met after the RST packet is transmitted, accordingly repeated transmission of the RST packet to the ECU 50 can be suppressed.

The control unit 220 may cause transmission of the RST packet to the ECU 50 to be performed repeatedly until the predetermined condition is met. Here, the predetermined condition may include the number of transmissions of the RST packet to the ECU 50 exceeding a predetermined number of times. The predetermined condition may include the time during which transmission of the RST packet to the ECU 50 is performed repeatedly exceeding a predetermined time. In this manner, a packet from the ECU 50 for which probability is high that it does not comply with the RST packet can be discarded.

The storage unit 230 stores transmission history of the RST packet to the ECU 50. The control unit 220 determines, based on the transmission history of the RST packet stored in the storage unit, whether to transmit the RST packet, or to perform a processing to discard the packet from the ECU 50 that should be transmitted through the wireless communication unit 34. In this manner, the control unit 220 determines whether to transmit the RST packet or to discard the packet from the ECU 50, taking into account the transmission history of the RST packet to the ECU 50. For example, when the control unit 220 determines, based on the transmission history of the RST packet, that the processing to discard the packet form the ECU 50 is to be performed, the control unit 220 may discard the packet from the ECU 50 without repeatedly transmitting the RST packet to the ECU 50. In this manner, the packet from the ECU 50 for which the probability is high that it does not comply with the RST packet can be quickly discarded. In this manner, a load for processing of transmitting the RST packet can be reduced.

The detection unit 210 detects that a communication state in a communication channel through the cellular communication unit 31 has become defective. The control unit 220 performs control to transmit the RST packet to the ECU 50 when it is detected that the communication state in the communication channel through the cellular communication unit 31 has become defective. The detection unit 210 detects that the communication state in the communication channel through the wireless LAN communication unit 32 has become defective. The control unit 220 performs control to transmit the RST packet to the ECU 50 when it is detected that the communication state in the communication channel through the wireless LAN communication unit 32 has become defective.

In connection to FIG. 2, the ECU 50 has been described as an example of the communication device. However, the communication terminal 100 is also an example of the communication device to which the RST packet is to be transmitted. Specifically, at the TCU 30, the wireless LAN communication unit 32 has a wireless access point functionality. In this manner, the communication terminal 100 can connect to the wireless LAN communication unit 32 as a station, and the communication processing unit 200 transmits the packet received from the communication terminal 100 to the outside through the wireless communication unit 34 (that is, the cellular communication unit 31 and/or wireless communication unit 34). In this manner, the communication terminal 100 can communicate with communication equipment connected to the communication network 90 by connecting to the TCU 30 through the wireless LAN communication unit 32. In this case, the control unit 220 may perform control to transmit the RST packet to the communication terminal 100 when it is detected that the communication state has become defective.

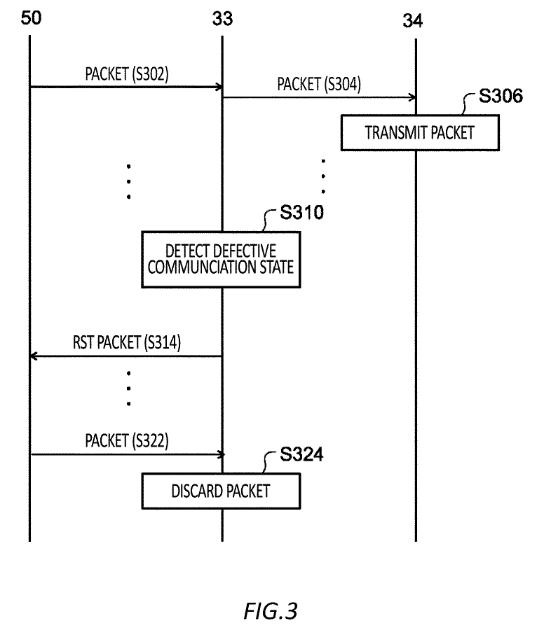

FIG. 3 illustrates an example of a sequence according to the communication control method performed at the communication system 22. At S302, the ECU 50 transmits, to the communication control unit 33, the packet that should be transmitted to the outside of the mobile object 20. At the communication control unit 33, upon receiving the packet transmitted from the ECU 50, the communication processing unit 200 outputs the received packet to the wireless communication unit 34 (S304). The wireless communication unit 34 transmits the packet acquired from the communication processing unit 200 (S306).

Subsequently, at S310, the detection unit 210 detects a defective communication state on a communication channel in which the ECU 50 transmits the packet through the wireless communication unit 34. At S314, the control unit 220 performs control to transmit the RST packet to the ECU 50 (S314). After transmitting the RST packet at S314, upon receiving, from the ECU 50, the packet unit 220 that should be transmitted on the communication channel in which a defective communication state is detected (S322), the control unit 220 performs control to discard the packet (S324). Discarding the packet may be performed when the number of times the packet that should be transmitted over the communication channel for which a defective communication state is detected is received exceeds a predetermine number.

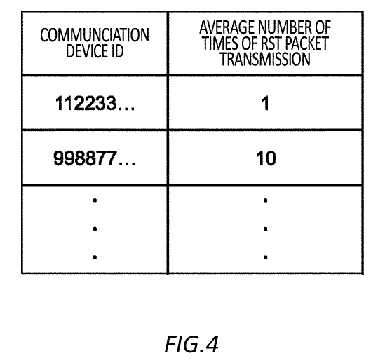

FIG. 4 illustrates a transmission history of the RST packet stored in the storage unit 230. The transmission history of the RST packet associates a communication device ID with an average number of times of transmission of the RST packet.

The communication device ID is information to uniquely identify the ECU 50 and the communication terminal 100. The communication device ID may be a MAC address, for example. For a communication device that can be identified by an IP address, the communication device ID may be the IP address. The average number of times of the RST packet transmission is an average value of the number of times that the RST packet was transmitted to a corresponding communication device, after defective communication has been detected over the communication channel.

When a defective communication state over the communication channel is detected, the control unit 220 identifies the communication device that is in communication over said communication channel. The control unit 220 refers to the transmission history of the RST packet, and acquires the average number of times of the RST packet transmission that is associated with the identification information of the communication device that is in communication over said communication channel. When the acquired average number of times of the RST packet transmission is less than a predetermined value, the control unit 220 determines to transmit the RST packet. On the other hand, when the acquired average number of times of the RST transmission is equal to or greater than the predetermined value, the control unit 220 determines to perform DROP processing without transmitting the RST packet.

In FIG. 4, an example in which the average number of times of the RST packet transmission is stored as the transmission history of the RST packet has been illustrated, but the average number of times of the RST packet transmission is an example of the transmission history of the RST packet. As another example, the an average value of a length of a period during which the RST packet isrepeatedly transmitted may be stored as the transmission history of the RST packet. Besides the above, the transmission history of the RST packet may include a history of the number of transmissions of the RST packet, or may include a history of a length of the period during which the RST packet is repeatedly transmitted.

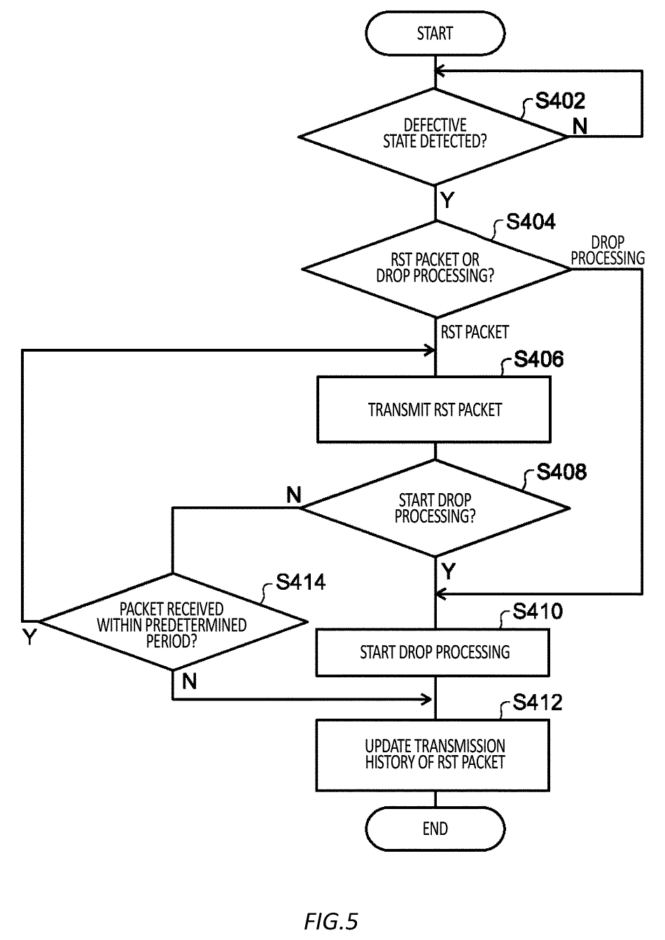

FIG. 5 illustrates an example of a flowchart according to the communication control method performed at the communication control unit 33.

At S402, the control unit 220 determines whether a defective communication state has been detected by the detection unit 210. When it is determined that a defective communication state has been detected, at S404, determination is made whether to transmit the RST packet to the communication device that is in communication over the communication channel for which the defective communication state has been detected, or to perform the DROP processing on the packet from said communication device. For example, as described in connection to FIG. 4, the control unit 220 may determine, based on the transmission history of the RST packet, whether to transmit the RST packet to said communication device, or to perform the DROP processing on the packet from said communication device. At S404, when it is determined that the DROP processing is to be performed, the processing is transferred to S410.

At S404, when it is determined that the RST packet is to be transmitted, at S406, the RST packet is transmitted to the communication device. At 408, the control unit 220 determines whether to start the DROP processing or not. For example, the control unit 220 may determine that the DROP processing is to be started when the number of transmissions of the RST packet after the defective communication state is detected exceeds a predetermined number of times. The control unit 220 may determine that the DROP processing is to be started when the time during which transmission of the RST packet is performed repeatedly after the defective communication state is detected exceeds a predetermined time.

When it is determined that the DROP processing is not to be started at S408, the processing is transferred to S414. At S414, the control unit 220 determines whether the packet that should be transmitted to the communication channel for which the defective communication state is detected has been received, within a predetermined period, from the communication device that transmitted the RST packet. At S414, when it is determined that the packet that should be transmitted to the communication channel for which the defective communication state is detected has been received within the predetermined period, the processing is transferred to S406. When it is determined that the packet that should be transmitted to the communication channel for which the defective communication state is detected has not been received within the predetermined period, the processing is transferred to S412.

When it is determined at S408 that the DROP processing is to be started, at S410, the DROP processing is started. Subsequently, at S412, the control unit 220 updates the transmission history of the RST packet stored in the storage unit 230, and ends the processing of the present flowchart.

When it is determined at S402 that the packet has not been received, at S414, whether the packet has been received within the predetermined period over the communication channel for which the defective communication state is detected is determined. At S414, when it is determined that the packet has been received within the predetermined period over the communication channel for which the defective communication state is detected, the processing is transferred to S402. At S414, when it is determined that the packet has not been received within the predetermined period over the communication channel for which the defective communication state is detected, the processing is transferred to S412.

As described above, with the TCU 30 according to the present embodiment, since when there is a defective communication state, the RST packet is transmitted to the communication device that is in communication with the communication channel with the defective communication state, unnecessary processings such as resending processing of the packet by the communication device can be prevented from being repeated. Further, when the RST packet is received in a case where the communication device is in communication through the wireless relay device 110, for example, it is possible to perform data communication by switching to cellular communication through the wireless base station 120.

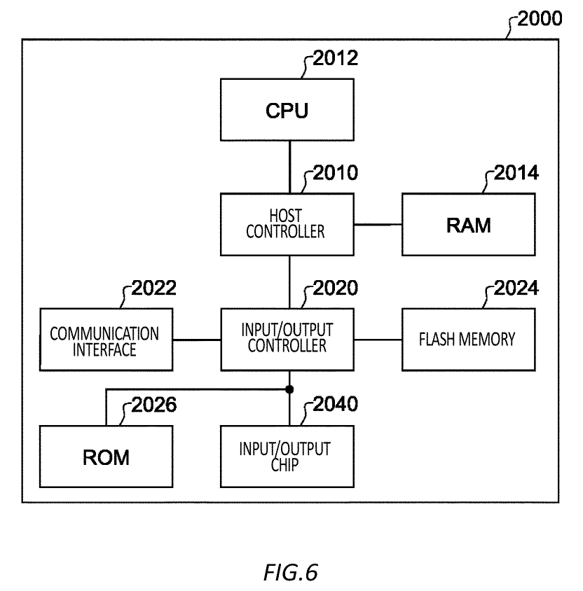

FIG. 6 illustrates an example of a computer 2000 that may entirely or partially implement a plurality of embodiments of the present invention. A program installed on the computer 2000 can cause the computer 2000 to function as the communication system 22 according to embodiments or each unit of said system, or various types of devices such as the TCU 30 or the like or each unit of said devices, to perform operation associated with said system or each unit of the system, or said device or each unit of said device, and/or to perform the process according to embodiments or steps of said process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 upon activation, and/or a program which depends on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer readable storage medium such as a CD-ROM, a DVD-ROM, or a memory card. The RAM 2014, the ROM 2026, or the flash memory 2024 is an example of the computer readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be achieved by executing operations or processing of information according to a use of the computer 2000.

For example, when a communication is executed between the computer 2000 and an external device, the CPU 2012 may execute a communication program loaded on the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The program or software module described above may be stored in a computer readable storage medium on the computer 2000 or near the computer 2000. A recording medium such as a hard disk or a RAM provided in a server system connected to a dedicated communication network or the Internet can be used as the computer readable storage medium. A program stored in the computer readable storage medium may be provided to the computer 2000 via a network.

When executed by the computer, the program that is installed on the computer 2000 and causes the computer 2000 to function as the TCU 30 may work with the CPU 2012 or the like to cause the computer 2000 to function as each unit of the TCU 30. Information processing written in these programs are read by the computer 2000 to cause the computer 2000 to function as each unit of the TCU 30, which is a specific means in which the software and various types of hardware resources are in cooperation with each other. Therefore, by means of these specific means, operation or processing of information according to the intended use of the computer 2000 in the present embodiment can be achieved, thereby allowing a specific TCU 30 according to the intended use to be built.

Various embodiments have been described with reference to the block diagrams and the like. In the block diagrams, each block may represent (1) a stage of a process in which an operation is executed, or (2) each unit of the apparatus having a role in executing the operation. A specific step and each unit may be implemented by a dedicated circuit, a programmable circuit supplied with computer readable instructions stored on a computer readable storage medium, and/or a processor supplied with computer readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like such as a flip-flop, a register, a field programmable gate array (FPGA), a programmable logic array (PLA), or the like.

The computer readable storage medium may include any tangible device capable of storing instructions to be executed by an appropriate device. Thereby, the computer readable storage medium having instructions stored therein forms at least a part of a product including instructions which can be executed to provide means for executing processing procedures or operations specified in the block diagrams. An example of the computer readable storage medium may include an electronic storage medium, a magnetic storage medium, an optical storage medium, an electromagnetic storage medium, a semiconductor storage medium, etc. A more specific example of the computer readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, or the like.

The computer readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as Smalltalk (registered trademark), JAVA (registered trademark), and C++, or the like, and a conventional procedural programming language such as a "C" programming language or a similar programming language.

The computer readable instruction are provided to the processor or programmable circuitry of programmable data processing devices such as a computer locally or via a local area network (LAN), a wide area network (WAN) such as the Internet, and the computer readable instruction may be executed in order to provide means to execute the operations specified in the described processing procedure or block diagrams.

Here, the computer may be a computer such as a personal computer (PC), a tablet computer, smartphone, a work station, a server computer, or a general purpose computer, or may be a computer system in which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. In addition, which portion of the program each of the plurality of processors is to execute may be statically determined by multi-processor aware programming.

While the present invention has been described by way of the embodiments, the technical scope of the present invention is not limited to the scope described in the above-described embodiments. It is apparent to persons skilled in the art that various alterations or improvements can be made to the above described embodiments. It is also apparent from the description of the claims that the form to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by "before", "prior to", or the like and as long as the output from a previous process is not used in a later process. Even if the operation flow is described by using phrases such as "first" or "next" for the sake of convenience in the claims, specification, and drawings, it does not necessarily mean that the process must be performed in this order.

### EXPLANATION OF REFERENCES

20: mobile object, 22: communication system, 30: TCU, 31: cellular communication unit, 32: wireless LAN communication unit, 33: communication control unit, 34: wireless communication unit, 50: ECU, 70: in-vehicle communication network, 90: communication network, 100: communication terminal, 110: wireless relay device, 120: wireless base station, 200: communication processing unit 210: detection unit, 220: control unit, 230: storage unit, 2000: computer, 2010: host controller, 2012: CPU, 2014: RAM, 2020: input/output controller, 2022: communication interface, 2024: flash memory, 2026: ROM, 2040: input/output chip.

What is claimed is:

1. A communication control device provided in a mobile object, the communication control device comprising: a communication processing unit which performs processing for transmitting, through a wireless communication unit provided in the mobile object, a packet transmitted from a communication device; a detection unit which detects that a communication state in a communication channel through the wireless communication unit has become defective; and a control unit which performs control to transmit an RST packet to the communication device when it is detected that the communication state has become defective.

2. The communication control device according to claim 1, wherein when a predetermined condition is met after an RST packet is transmitted to the communication device, the control unit starts a processing of discarding a packet from the communication device that should be transmitted through the wireless communication unit.

3. The communication control device according to claim 2, wherein the control unit causes transmission of an RST packet to the communication device to be performed repeatedly until the predetermined condition is met.

4. The communication control device according to claim 3, wherein the predetermined condition includes a number of transmissions of an RST packet to the communication device exceeding a predetermined number of times.

5. The communication control device according to claim 3, wherein the predetermined condition includes a time during which transmission of an RST packet to the communication device is performed repeatedly exceeding a predetermined time.

6. The communication control device according to claim 1, further comprising: a storage unit which stores a transmission history of an RST packet to the communication device, wherein the control unit determines, based on the transmission history of the RST packet stored in the storage unit, whether to transmit an RST packet or to discard a packet from the communication device that should be transmitted through the wireless communication unit.

7. The communication control device according to claim 1, wherein the wireless communication unit includes a cellular communication unit that performs cellular communication and a wireless LAN communication unit that performs wireless LAN communication, the detection unit detects that a communication state in a communication channel through the cellular communication unit has become defective and that a communication state in a communication channel through the wireless LAN communication unit has become defective, and the control unit performs: control to transmit an RST packet to the communication device when it is detected that a communication state in a communication channel through the cellular communication unit has become defective; and control to transmit an RST packet to the communication device when it is detected that a communication state in a communication channel through the wireless LAN
communication unit has become defective.

8. The communication control device according to claim 1, wherein the mobile object is a vehicle, and the communication device is an ECU.

9. The communication control device according to claim 2, further comprising: a storage unit which stores a transmission history of an RST packet to the communication device, wherein the control unit determines, based on the transmission history of the RST packet stored in the storage unit, whether to transmit an RST packet or to discard a packet from the communication device that should be transmitted through the wireless communication unit.

10. The communication control device according to claim 3, further comprising: a storage unit which stores a transmission history of an RST packet to the communication device, wherein the control unit determines, based on the transmission history of the RST packet stored in the storage unit, whether to transmit an RST packet or to discard a packet from the communication device that should be transmitted through the wireless communication unit.

11. The communication control device according to claim 4, further comprising: a storage unit which stores a transmission history of an RST packet to the communication device, wherein the control unit determines, based on the transmission history of the RST packet
stored in the storage unit whether to transmit an RST packet or to discard a packet from the communication device that should be transmitted through the wireless communication unit.

12. The communication control device according to claim 5, further comprising: a storage unit which stores a transmission history of the RST packet to the communication device, wherein the control unit determines, based on the transmission history of an RST packet stored in the storage unit, whether to transmit an RST packet or to discard a packet from the communication device that should be transmitted through the wireless communication unit.

13. The communication control device according to claim 2, wherein the wireless communication unit includes a cellular communication unit that performs cellular communication and a wireless LAN communication unit that performs wireless LAN communication, the detection unit detects that a communication state in a communication channel through the cellular communication unit has become defective and that a communication state in a communication channel through the wireless LAN communication unit has become defective, and the control unit performs: control to transmit an RST packet to the communication device when it is detected that a communication state in a communication channel through the cellular communication unit has become defective; and control to transmit an RST packet to the communication device when it is detected that a communication state in a communication channel through the wireless LAN communication unit has become defective.

14. The communication control device according to claim 3, wherein the wireless communication unit includes a cellular communication unit that performs cellular communication and a wireless LAN communication unit that performs wireless LAN communication, the detection unit detects that a communication state in a communication channel through the cellular communication unit has become defective and that a communication state in a communication channel through the wireless LAN communication unit has become defective, and the control unit performs: control to transmit an RST packet to the communication device when it is detected that a communication state in a communication channel through the cellular communication unit has become defective; and control to transmit an RST packet to the communication device when it is detected that a communication state in a communication channel through the wireless LAN communication unit has become defective.

15. The communication control device according to claim 4, wherein the wireless communication unit includes a cellular communication unit that performs cellular communication and a wireless LAN communication unit that performs wireless LAN communication, the detection unit detects that a communication state in a communication channel through the cellular communication unit has become defective and that a communication state in a communication channel through the wireless LAN communication unit has become defective, and the control unit performs:
control to transmit an RST packet to the communication device when it is detected that a communication state in a communication channel through the cellular communication unit has become defective; and
control to transmit an RST packet to the communication device when it is detected that a communication state in a communication channel through the wireless LAN communication unit has become defective.

16. The communication control device according to claim 5, wherein the wireless communication unit includes a cellular communication unit that performs cellular communication and a wireless LAN communication unit that performs wireless LAN communication, the detection unit detects that a communication state in a communication channel through the cellular communication unit has become defective and that a communication state in a communication channel through the wireless LAN communication unit has become defective, and the control unit performs: control to transmit an RST packet to the communication device when it is detected that a communication state in a communication channel through the cellular communication unit has become defective; and control to transmit an RST packet to the communication device when it is detected that a communication state in a communication channel through the wireless LAN communication unit has become defective.

17. The communication control device according to claim 2, wherein the mobile object is a vehicle, and
the communication device is an ECU.

18. The communication control device according to claim 3, wherein the mobile object is a vehicle, and the communication device is an ECU.

19. A communication control method which is performed at a communication control device provided in a mobile object, the communication control method comprising: performing control to transmit, through a wireless communication unit provided in the mobile object, a packet transmitted from a communication device; detecting that a communication state in a communication channel through the wireless communication unit has become defective; and when it is detected that the communication state has become defective, performing control to transmit an RST packet to the communication device.

20. A non-transitory computer readable storage medium having stored thereon a program for a communication control device provided in a mobile object, the program causes a computer to function as: a communication processing unit which performs processing for transmitting, through a wireless communication unit provided in the mobile object, a packet transmitted from a communication device; a detection unit which detects that a communication state in a communication channel through the wireless communication unit has become defective; and a control unit which performs control to transmit an RST packet to the communication
device when it is detected that the communication state has become defective.
